(19) United States
(12) Patent Application Publication
(10) Pub. No.: US 2024/0027888 A1
(43) Pub. Date: Jan. 25, 2024

(54) PROJECTION OPTICAL APPARATUS AND PROJECTOR

(71) Applicant: SEIKO EPSON CORPORATION, Tokyo (JP)

(72) Inventor: Yuta ITO, Azumino-shi (JP)

(21) Appl. No.: 18/358,086

(22) Filed: Jul. 25, 2023

(30) Foreign Application Priority Data
Jul. 25, 2022 (JP) 2022-117786

(51) Int. Cl. G03B 21/20; G03B 21/16; G03B 21/14

(52) U.S. Cl. CPC G03B 21/2066; G03B 21/16; G03B 21/145

(57) ABSTRACT

A projection optical apparatus according to an aspect of the present disclosure includes an optical system that image light enters, a reflector that reflects the image light that exits out of the optical system, and an enclosure that houses the optical system and the reflector, and the reflector includes a base having a first surface on which light is incident and a second surface opposite from the first surface, a reflection layer provided at the first surface of the base, and a heat conductive layer provided at the second surface of the base. The heat conductive layer has heat conductivity higher than the heat conductivity of the base.

The present application is based on, and claims priority from JP Application Serial Number 2022-117786, filed Jul. 25, 2022, the disclosure of which is hereby incorporated by reference herein in its entirety.

### BACKGROUND

### 1. Technical Field

The present disclosure relates to a projection optical apparatus and a projector.

### 2. Related Art

In recent years, there has been a demand for short-focal-length projectors that are compact yet capable of displaying large projected images. As such a short-focal-length projector, there is a technology using a projection optical apparatus having a configuration in which lenses are combined with a concave mirror to enlarge an image reflected off the mirror and project the enlarged image onto a screen (see, JP-A-2011-085922, for example).

In the short-focal-length projector described above, image light is incident on the mirror of the projection optical apparatus with the image light focused into a spot on the mirror. The mirror may therefore be deformed due to heat generated by the locally high illuminance of the image light. The image light reflected off the deformed mirror is undesirably projected at a position off a predetermined position on the screen. There is therefore a problem of deterioration in the quality of the projected image due to the partial movement of the projected image light.

### SUMMARY

To solve the problem described above, according to an aspect of the present disclosure, there is provided a projection optical apparatus including an optical system that image light enters, a reflector that reflects the image light that exits out of the optical system, and an enclosure that houses the optical system and the reflector, the reflector including a base having a first surface on which the image light is incident and a second surface opposite from the first surface, a reflection layer provided at the first surface of the base, and a heat conductive layer provided at the second surface of the base, the heat conductive layer having heat conductivity higher than heat conductivity of the base.

According to another aspect of the present disclosure, there is provided a projector including a light source apparatus that outputs light, a light modulator that modulates the light from the light source apparatus, and the projection optical apparatus according to the aspect described above that projects modulated image light from the light modulator.

### BRIEF DESCRIPTION OF THE DRAWINGS

FIG. 1 shows a schematic configuration of a projector according to an embodiment.

FIG. 2 is a cross-sectional view showing a schematic configuration of a projection optical apparatus provided in the projector.

FIG. 3 shows an illuminance distribution formed on a reflection mirror.

### DESCRIPTION OF EXEMPLARY EMBODIMENTS

An embodiment of the present disclosure will be described below in detail with reference to the drawings. In the drawings used in the description below, a characteristic portion is enlarged for convenience in some cases for clarity of the characteristic thereof, and the dimension ratio and other factors of each component are therefore not always equal to actual values.

An example of a projector according to the present embodiment will be described.

The projector according to the present embodiment is a projection-type image display apparatus that displays a full-color image on a screen (projection receiving surface). The projector includes three light modulators formed of liquid crystal light valves that modulate color light formed of red light, green light, and blue light.

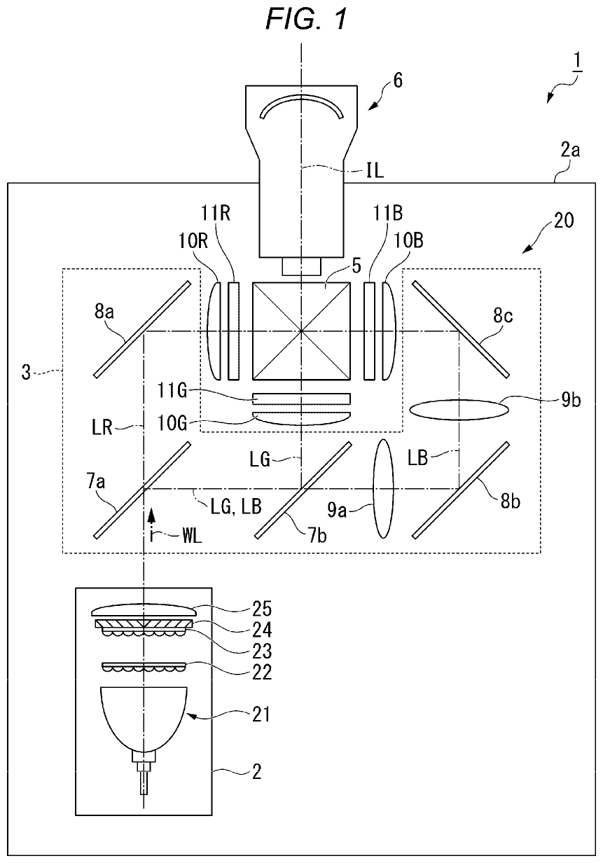

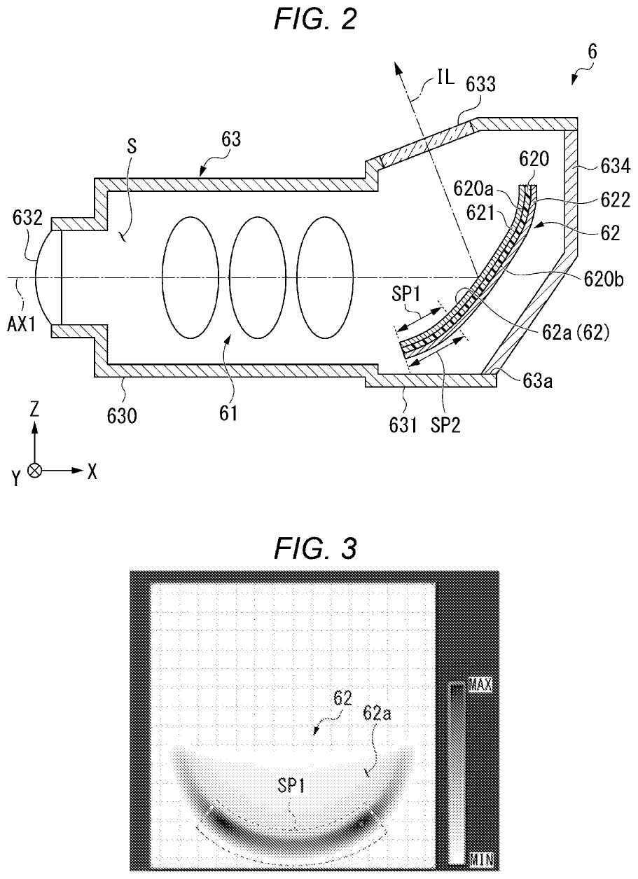

FIG. 1 shows a schematic configuration of the projector according to the present embodiment. FIG. 2 is a cross-sectional view showing a schematic configuration of a projection optical apparatus provided in the projector according to the present embodiment.

A projector 1 according to the present embodiment includes a body section 20, an exterior enclosure 2a, and a projection optical apparatus 6, as shown in FIG. 1. The body section 20 is housed in the exterior enclosure 2a. The exterior enclosure 2a is made, for example, of a resin material, and has a configuration in which a plurality of members are combined with each other.

The projection optical apparatus 6 is disposed so as to partially protrude from the exterior enclosure 2a. The projection optical apparatus 6 according to the present embodiment is a projection lens unit capable of ultra-short focal length projection. With the projection optical apparatus 6 attached, the projector 1 can be installed at a position close to the screen and project an image. The projection optical apparatus 6 is, however, not necessarily detachable from and attachable to the body section 20. The configuration of the projection optical apparatus 6 will be described later in detail.

The body section 20 includes a light source apparatus 2 as an illumination system, a color separation system 3, light modulators 11R, 11G, and 11B, and a light combining system 5.

The light source apparatus 2 includes a light source 21, a first lens array 22, a second lens array 23, a polarization converter 24, and a superimposing lens 25. The first lens array 22 and the second lens array 23 each have a configuration in which a plurality of microlenses are arranged in a matrix in a plane perpendicular to the optical axis.

In the projector 1 according to the present embodiment, a lamp that is a discharge-type light source is employed as the light source 21, but the light source 21 is not limited to a discharge-type light source. The light source 21 may, for example, be a solid-state light source, such as a light emitting diode and a laser, or a light source apparatus including a wavelength converter containing a phosphor that emits fluorescence when irradiated with excitation light.

Light emitted from the light source 21 is divided by the first lens array 22 into a plurality of sub-luminous fluxes. The plurality of sub-luminous fluxes are superimposed by the second lens array 23 and the superimposing lens 25 on one another in an effective display region of each of the three light modulators 11R, 11G, and 11B, which are each an illumination target. That is, the first lens array 22, the second lens array 23, and the superimposing lens 25 form an optical integration system that illuminates the light modulators 11R, 11G, and 11B with the light emitted from the light source 21 and having a substantially uniform illuminance distribution.

The polarization converter 24 converts the light emitted from the light source 21, which is non-polarized light, into linearly polarized light that can be used by the three light modulators 11R, 11G, and 11B.

The color separation system 3 separates illumination light WL from the light source apparatus 2 into red light LR, green light LG, and blue light LB. The color separation system 3 generally includes a first dichroic mirror 7a, a second dichroic mirror 7b, a first total reflection mirror 8a, a second total reflection mirror 8b, a third total reflection mirror 8c, a first relay lens 9a, and a second relay lens 9b.

The first dichroic mirror 7a separates the illumination light WL from the light source apparatus 2 into the red light LR and other light formed of the green light LG and blue light LB. The first dichroic mirror 7a transmits the separated red light LR and reflects the separated green light LG and blue light LB. On the other hand, the second dichroic mirror 7b reflects the green light LG and transmits the blue light LB to separate the other light into the green light LG and the blue light LB.

The first total reflection mirror 8a is disposed in the optical path of the red light LR and reflects the red light LR having passed through the first dichroic mirror 7a toward the light modulator 11R. On the other hand, the second total reflection mirror 8b and the third total reflection mirror 8c are disposed in the optical path of the blue light LB and guide the blue light LB having passed through the second dichroic mirror 7b to the light modulator 11B. The green light LG is reflected off the second dichroic mirror 7b toward the light modulator 11G.

The first relay lens 9a and the second relay lens 9b are disposed downstream from the second dichroic mirror 7b in the optical path of the blue light LB.

The light modulator 11R modulates the red light LR in accordance with image information to form image light corresponding to the red light LR. The light modulator 11G modulates the green light LG in accordance with image information to form image light corresponding to the green light LG. The light modulator 11B modulates the blue light LB in accordance with image information to form image light corresponding to the blue light LB.

The light modulators 11R, 11G, and 11B are each, for example, a transmissive liquid crystal panel. Pixels are arranged in each of the liquid crystal panels and modulate the light incident thereon on a pixel basis in accordance with the image information. Polarizers that are not shown are disposed on the light incident side and the light exiting side of each of the liquid crystal panels.

Field lenses 10R, 10G, and 10B are disposed at the light incident side of the light modulators 11R, 11G, and 11B, respectively. The field lenses 10R, 10G, and 10B parallelize the red light LR, the green light LG, and the blue light LB to be incident on the respective light modulators 11R, 11G, and 11B.

The light combining system 5 receives the image light from the light modulator 11R, the image light from the light modulator 11G, and the image light from the light modulator 11B. The light combining system 5 combines the image light corresponding to the red light LR, the image light corresponding to the green light LG, and the image light corresponding to the blue light LB with one another and outputs the combined image light toward the projection optical apparatus 6. The light combining system 5 is formed, for example, of a cross dichroic prism. The combined light generated by the light combining system 5 exits toward the projection optical apparatus 6.

The combined light having exited out of the body section 20 is projected as image light IL via the projection optical apparatus 6 onto the projection receiving surface, such as the screen that is not shown.

The projection optical apparatus 6 will be described below.

The projection optical apparatus 6 according to the present embodiment projects an image displayed in the reduction-side conjugate plane into the enlargement-side conjugate plane to generate a projected image. In the present embodiment, the reduction-side conjugate plane corresponds to a display surface of the liquid crystal panel of each of the light modulators 11R, 11G, and 11B, and the enlargement-side conjugate plane corresponds to the screen, which is the projection receiving surface.

The projection optical apparatus 6 according to the present embodiment forms an intermediate image of the displayed image at the position conjugate to the display surface of each of the light modulators 11R, 11G, and 11B, which is the reduction-side conjugate plane, and enlarges and projects the intermediate image onto the screen, which is the enlargement-side conjugate plane.

The following description with reference to the drawings will be made by using an XYZ orthogonal coordinate system as required. The axis Z is an axis along the upward-downward direction of an image projected by the projection optical apparatus 6 onto the screen. The axis X is an axis parallel to an optical axis AX1 of the projection optical apparatus 6. The axis Y is an axis perpendicular to the axes X and Z and extending along the rightward-leftward direction of an image projected by the projection optical apparatus 6 onto the screen.

FIG. 2 is a cross-sectional view showing a schematic configuration of the projection optical apparatus 6 according to the present embodiment.

The projection optical apparatus 6 includes a lens group (optical system) 61, a reflection mirror (reflector) 62, and a lens unit enclosure (enclosure) 63, which houses the lens group 61 and the reflection mirror 62, as shown in FIG. 2.

The lens group 61 is formed of a plurality of lenses and causes the image light IL from the body section 20 to exit toward the reflection mirror 62. In the lens group 61, the plurality of lenses are arranged along the optical axis AX1. The plurality of lenses that constitute the lens group 61 include lenses having a variety of shapes, such as convex and concave lenses. The number, shape, dimensions, and arrangement of the lenses that constitute the lens group 61 are not limited to specific ones.

The reflection mirror 62 reflects the image light IL having exited out of the lens group 61 and deflects the optical path of the image light IL. The reflection mirror 62 projects the reflected image light IL onto the projection receiving surface, which is the enlargement-side conjugate plane. A reflection surface 62a of the reflection mirror 62 is formed of an aspherical mirror that reflects the image light IL while angularly widening the image light IL. The reflection mirror 62 is so disposed that the reflection surface 62a faces upward (side facing positive end of direction Z) and the side opposite from the side toward which the light exits out of the lens group 61 (side facing negative end of direction X). In the present embodiment, the reflection mirror 62 reflects the chief ray of the image light IL, which travels along the optical axis AX1 of the lens group 61, obliquely backward at an acute angle with respect to the optical axis AX1. The image light IL reflected off the reflection mirror 62 exits toward the screen via a light exiting section 633 of the lens unit enclosure 63, which will be described later.

Based on the configuration described above, the projection optical apparatus 6 according to the present embodiment can enlarge and project the image light IL onto the screen disposed at a short distance from the projector 1.

The lens unit enclosure 63 includes a lens barrel 630, a mirror holder 631, a light incident section 632, the light exiting section 633, and a cover member 634. The material, shape, dimensions, and other factors of the lens unit enclosure 63 are not limited to specific ones.

The lens barrel 630 is a portion that houses the lens group 61, and the mirror holder 631 is a portion that holds the reflection mirror 62. Although not shown, the lens barrel 630 includes supports that support the individual lenses that constitute the lens group 61, and the mirror holder 631 includes a support that supports the reflection mirror 62.

The light incident section 632 captures the image light IL having exited out of the body section 20 into the projection optical apparatus 6. The light exiting section 633 causes the image light IL reflected off the reflection mirror 62 out of the projection optical apparatus 6. The light incident section 632 and the light exiting section 633 are each formed, for example, of a light transmissive window member. In the present embodiment, the light incident section 632, for example, has a lens shape, which allows efficient capture of the image light IL.

The lens unit enclosure 63 has an opening 63a. In the present embodiment, the opening 63a is provided at the mirror holder 631 of the lens unit enclosure 63.

The opening 63a causes the interior space of the lens unit enclosure 63 to communicate with the exterior thereof. The lens group 61 and the reflection mirror 62 are detachable from and attachable to the interior of the lens unit enclosure 63 via the opening 63a. The cover member 634 is detachable from and attachable to the lens unit enclosure 63 to block the opening 63a.

The cover member 634 hermetically seals the interior space of the lens unit enclosure 63. That is, the lens unit enclosure 63 in the present embodiment has a sealing structure that seals a housing space S, which houses the lens group 61 and the reflection mirror 62. The thus configured lens unit enclosure 63, which suppresses entry of dust into the inner housing space S, can suppress deterioration in the optical characteristics of the lens group 61 and the reflection mirror 62 due to dust that adheres thereto, and deformation of and damage to the lens group 61 and the reflection mirror 62 due to the dust caused to burn.

In a short-focal-distance projector, in general, by employing a configuration in which image light is so reflected off a reflection mirror that the image light is enlarged and projected onto a screen, the light density of the image light becomes uneven on the reflection mirror, causing the illuminance distribution formed on the reflection mirror to undesirably have locally high illuminance regions.

Also in the projection optical apparatus 6 according to the present embodiment, the illuminance distribution formed on the reflection mirror 62 by the image light IL having exited out of the body section 20 has locally high illuminance regions.

FIG. 3 shows the illuminance distribution formed on the reflection mirror 62 in the present embodiment. Specifically, FIG. 3 shows the illuminance distribution of the image light IL formed on a reflection layer 621 and further shows the maximum illuminance of the image light IL (black) and the minimum illuminance of the image light IL (white).

On the reflection mirror 62 in the present embodiment, the image light IL at a lower portion (portion facing negative end of the direction Z shown in FIG. 2) of the reflection surface 62a has locally high illuminance, as shown in FIG. 3. An illuminance distribution SP of the image light IL has a first region SP1, where the illuminance is higher than a predetermined value. That is, the first region SP1 means a region of the reflection surface 62a where the illuminance of the image light IL is locally high.

The predetermined value that defines the first region SP1 is preferably greater than or equal to 50% of the maximum illuminance, more preferably, greater than or equal to 60% thereof, and most preferably, greater than or equal to 70% thereof.

In the projection optical apparatus 6 according to the present embodiment, the heat dissipation capability of the reflection mirror 62 is enhanced to lower the temperature of the reflection mirror 62 to suppress local deformation of the reflection mirror 62, so that a partial shift of the image light that forms the projected image caused by the heat is suppressed.

The configurations of key parts of the reflection mirror 62 in the present embodiment will be described below.

The reflection mirror 62 in the present embodiment includes a base 620, the reflection layer 621, and a heat conductive layer 622. The base 620 has an inner surface (first surface) 620a, on which the image light is incident, and an outer surface (second surface) 620b, which is opposite from the inner surface 620a. The inner surface 620a of the base 620 has a concave shape. Specifically, the inner surface 620a has, for example, a spherical shape, an aspherical shape, or a free-form surface shape.

In the present embodiment, the base 620 is made of a plastic material and may instead be made of glass. In particular, since plastic is more workable than glass, the inner surface 620a can be readily and precisely formed into a desired shape. On the other hand, plastic tends to change in shape due to heat, and when the temperature of the reflection layer 621 becomes too high, the base 620 may be deformed.

The reflection layer 621 is formed along the inner surface 620a. A surface 621a of the reflection layer 621 therefore has a concave shape that conforms to the inner surface 620a. In the present embodiment, the surface 621a of the reflection layer 621 corresponds to the reflection surface 62a of the reflection mirror 62.

The reflection layer 621 in the present embodiment is formed of a metallic or dielectric film. The metallic film that constitutes the reflection layer 621 is made, for example, of aluminum or silver. The dielectric film that constitutes the reflection layer 621 is, for example, a film that reflects visible light having wavelengths ranging from 400 nm to 700 nm.

In the present embodiment, the reflection layer 621 is formed by using vapor deposition. The thickness of the reflection layer 621 is set, for example, at a value smaller than or equal to 1 μm. It is assumed that the surface 621a of the reflection layer 621 is a quasi-mirror-finish or mirror-finish surface. Specifically, the inner surface 620a of the base 620 is so formed that the surface roughness (Rz) of the surface 621a of the reflection layer 621 is smaller than or equal to 0.2 μm.

The heat conductive layer 622 is provided at least at part of the outer surface 620b of the base 620.

In the present embodiment, the heat conductive layer 622 is provided at least at a second region SP2 of the outer surface 620b, as shown in FIG. 2. The second region SP2 is the region corresponding to the first region SP1 of the reflection layer 621.

Specifically, the second region SP2 corresponding to the first region SP1 is a region of the outer surface 620b that overlaps with the outer shape of the first region SP1 in the direction of the shortest thickness of the reflection layer 621 and the base 620. The direction of the shortest thickness of the reflection layer 621 corresponds to the direction along a surface normal to the surface 621a of the reflection layer 621, and the direction of the shortest thickness of the base 620 corresponds to the direction along a surface normal to the inner surface 620a, which is the surfaces of the base 620.

The first region SP1 of the reflection layer 621 is a region where the illuminance is locally high and is therefore the hottest region of the surface 621a of the reflection layer 621. That is, it can be said that out of the outer surface 620b of the base 620, the second region SP2 corresponding to the first region SP1 is the region to which the heat of the first region SP1 is likely to be transferred and is therefore the hottest region.

In the present embodiment, since the heat conductive layer 622 is provided at least at the second region SP2 of the outer surface 620b as described above, the heat of the first region SP1, which is the hottest region of the surface 621a of the reflection layer 621, can be conducted and dissipated to the heat conductive layer 622. The temperature of the first region SP1 can therefore be efficiently lowered, whereby the temperature of the reflection mirror 62 can be efficiently lowered.

The heat conductive layer 622 is preferably provided in an area greater than or equal to 80% of the outer surface 620b and including the second region SP2, more preferably, across the entire outer surface 620b. The heat dissipation capability of the reflection mirror 62 can thus be further enhanced.

In the projection optical apparatus 6 according to the present embodiment, the lens unit enclosure 63 having the sealed structure tends to accumulate heat therein. In contrast, the reflection mirror 62 having heat dissipation capability enhanced by the heat conductive layer 622 is unlikely to be affected by the heat accumulated in the enclosure. The projection optical apparatus 6 according to the present embodiment therefore allows both improvement in dust resistance of the lens unit enclosure 63 and cooling of the reflection mirror 62.

The heat conductive layer 622 in the present embodiment only needs to be made of a material having heat conductivity higher than that of the base 620, and is made of a metal that excels in heat conductivity, such as silver, copper, gold, and aluminum. A method for forming the heat conductive layer 622 can, for example, be vapor deposition, sputtering, or plating. The plating includes electroless plating and electroplating.

In the present embodiment, the heat conductive layer 622 is formed by using the plating. Using the plating allows formation of the heat conductive layer 622 having a thickness greater than or equal to several micrometers at low cost. The surface roughness (Rz) of the heat conductive layer 622 formed by using the plating is greater than or equal to 1 μm.

Therefore, in the present embodiment, the heat conductive layer 622 is thicker than the reflection layer 621. According to the configuration described above, an increase in the thickness of the heat conductive layer 622 allows improvement in the amount of heat conducted by the heat conductive layer 622, whereby the heat of the reflection layer 621 can be efficiently conducted toward the heat conductive layer 622. The efficient dissipation of the heat from the reflection layer 621 therefore allows an efficient decrease in the temperature of the reflection mirror 62.

In the present embodiment, the surface roughness (Rz) of the heat conductive layer 622 is greater than the surface roughness (Rz) of the reflection layer 621. According to the configuration described above, by increasing the surface roughness of the heat conductive layer 622, minute irregularities are formed at the surface of the heat conductive layer 622. The area over which the surface of the heat conductive layer 622 is in contact with the air therefore increases, so that the heat dissipation capability of the heat conductive layer 622 is enhanced, resulting in enhancement of the heat dissipation capability of the reflection layer 621, whereby an increase in the temperature of the reflection mirror 62 can be suppressed.

The outer surface 620b of the base 620 may instead be roughened to provide a plurality of irregularity structures. In this case, the surface of the heat conductive layer 622 has an irregular shape that conforms to the irregularity structures of the outer surface 620b, whereby the surface area of the heat conductive layer 622 can be increased.

The present embodiment requires management of the conditions under which the reflection layer 621 is deposited with the surface precision taken into account. Therefore, when the reflection layer 62 is formed, it is desirable that the reflection layer 621 is deposited on the inner surface 620a of the base 620, and the heat conductive layer 622 is then formed at the outer surface 620b of the base 620.

The flexibility of the conditions under which the reflection layer 621 is deposited can thus be ensured, whereby a reflection mirror 62 including a high-surface-precision reflection layer 621 can be manufactured.

As described above, the projection optical apparatus 6 according to the present embodiment includes the lens group 61, which the image light IL enters, the reflection mirror 62, which reflects the image light IL having exited out of the lens group 61, and the lens unit enclosure 63, which houses the lens group 61 and the reflection mirror 62, and the reflection mirror 62 includes the base 620, which has the inner surface 620a, on which the image light IL is incident, and the outer surface 620b opposite from the inner surface 620a, the reflection layer 621, which is provided at the inner surface 620a of the base 620, and the heat conductive layer 622, which is provided at the outer surface 620b of the base 620.

In the projection optical apparatus 6 according to the present embodiment, the reflection mirror 62, which reflects the image light IL, includes the heat conductive layer 622 opposite from the reflection layer 621, and the heat conductive layer 622 dissipates the heat of the reflection layer 621, whereby the temperature of the reflection mirror 62 can be lowered.

Even when the image light IL having an illuminance distribution containing locally high illuminance is incident on the reflection layer 621, the temperature of the reflection layer 621 can be satisfactorily lowered, whereby a situation in which local temperature unevenness occurs at the reflection layer 621 can also be suppressed.

The projection optical apparatus 6 according to the present embodiment, which suppresses deformation of the reflection mirror 62 due to a locally high temperature of the reflection layer 621, can therefore project a high-quality image having a suppressed partial shift of the projected image light caused by the heat of the reflection mirror 62.

The projector 1 according to the present embodiment includes the light source apparatus 2, which outputs illumination light, the light modulators 11R, 11G, and 11B, which modulate the illumination light from the light source apparatus 2, and the projection optical apparatus 6, which projects the light modulated by the light modulators 11R, 11G, and 11B.

The projector 1 according to the present embodiment, which includes the projection optical apparatus 6, which suppresses a partial shift of the image light that forms the projected image caused by the heat of the reflection mirror 62, can be a single-focus projector that projects a high-quality image onto a screen over a short distance.

The projector 1 according to the present embodiment is, for example, optimum for an interactive projector having an interactive function of reflecting on-screen detected position information in the projected image.

An interactive projector in general projects infrared light in the form of a grid pattern on a screen via an optical system different from a projection optical apparatus, and acquires information on a position on a projected image to which a user's fingertip, the tip of a pen, or any other pointing object points based on the grid pattern. It is a prerequisite for an interactive projector that the coordinates in the projected image coincide with the coordinates in the grid pattern. Therefore, if the image light that forms the projected image moves, the coordinates in the projected image do not coincide with the coordinates in the grid pattern, so that the interactive function cannot be fully provided. In contrast, the projector 1 according to the present embodiment can suppress a shift of the image light that forms the projected image caused by the heat of the reflection mirror 62, whereby the interactive function can be provided in a stable manner.

The technical scope of the present disclosure is not limited to the embodiment described above, and a variety of changes can be made thereto to the extent that the changes do not depart from the intent of the present disclosure.

In addition to the above, the number, arrangement, shape, material, and other specific configurations of the variety of components that constitute the light source apparatus are not limited to those in the embodiment described above and can be changed as appropriate.

For example, the aforementioned embodiment has been described with reference to the case where the reflection mirror 62 is a mirror having the concave reflection surface 62a, and the present disclosure is also applicable to a projection optical apparatus using a reflection mirror having a convex or planar reflection surface.

The aforementioned embodiment has been described with reference to the projection optical apparatus 6 used in the projector 1, which projects visible light as the image light onto the screen. The projection optical apparatus 6 therefore projects visible light. Depending on the type and application of the light source of the projector, however, a film that reflects near-infrared or infrared light may be used as the dielectric film that constitutes the reflection layer 621.

The light modulators 11R, 11G, and 11B are each not limited to a transmissive liquid crystal panel. The light modulators 11R, 11G, and 11B may instead each be a reflective light modulator, such as a reflective liquid crystal panel. Still instead, for example, a digital micromirror device that includes micromirrors as pixels and controls the direction in which light incident thereon exits on a micromirror basis to modulate the light emitted from the light source 21 may be employed. Furthermore, the configuration in which a light modulator is provided for each of a plurality of color luminous fluxes is not necessarily employed, and a single light modulator may modulate the plurality of color luminous fluxes in a time division manner.

In the embodiment described above, the light source apparatus according to the present disclosure is used in a projector by way of example, but not necessarily. The light source apparatus according to the present disclosure may be used as a lighting apparatus, such as a headlight of an automobile.

The present disclosure will be summarized below as additional remarks.

### Additional Remark 1

A projection optical apparatus including an optical system that image light enters, a reflector that reflects the image light that exits out of the optical system, and an enclosure that houses the optical system and the reflector, the reflector including a base having a first surface on which the image light is incident and a second surface opposite from the first surface, a reflection layer provided at the first surface of the base, and a heat conductive layer provided at the second surface of the base, the heat conductive layer having heat conductivity higher than heat conductivity of the base.

In the thus configured projection optical apparatus, the reflector, which reflects light, includes the heat conductive layer opposite from the reflection layer, and the heat conductive layer dissipates the heat of the reflection layer, whereby the temperature of the reflector can be lowered.

Even when the light with which the reflection layer is illuminated has a distribution containing locally high illuminance, the temperature of the reflection layer is satisfactorily lowered, whereby the situation in which local temperature unevenness occurs at the reflection layer can be suppressed.

The projection optical apparatus having the configuration described above, in which the reflection layer of the reflector is unlikely to become locally hot, therefore suppresses deformation of the hot portions of the reflector. A high-quality image having a suppressed partial shift of the projected image light caused by the heat of the reflector can therefore be projected.

### Additional Remark 2

The projection optical apparatus described in the additional remark 1, in which an illuminance distribution formed by the image light at the reflection layer has a first region where the illuminance is higher than a predetermined value, and the heat conductive layer is provided at the second surface at least at a second region thereof corresponding to the first region.

According to the configuration described above, in which the heat conductive layer is provided at least at the second region of the second surface as described above, the heat can be efficiently dissipated from the first region, which is the hottest region of the surface of the reflection layer, toward the heat conductive layer. The temperature of the first region, which is the hottest region, is therefore efficiently lowered, whereby the temperature of the reflector can be efficiently lowered.

### Additional Remark 3

The projection optical apparatus described in the additional remark 1 or 2, in which the enclosure has a hermetically sealed structure that seals a housing space that houses the optical system and the reflector.

The configuration described above, which suppresses entry of dust into the housing space in the enclosure, suppresses deterioration in the optical characteristics of the optical system and the reflector due to dust that adheres thereto, and deformation of and damage to the optical system and the reflector due to the dust caused to burn.

### Additional Remark 4

The projection optical apparatus described in any one of the additional remarks 1 to 3, in which the base is made of a plastic material.

The configuration described above can improve the workability of the reflector. The reflector can therefore be readily processed into a desired shape.

### Additional Remark 5

The projection optical apparatus described in any one of the additional remarks 1 to 4, in which the reflection layer and the heat conductive layer are each made of a metal material, and the heat conductive layer is thicker than the reflection layer.

According to the configuration described above, the amount of heat conducted by the heat conductive layer is improved, whereby the heat of the reflection layer can be efficiently conducted toward the heat conductive layer. The efficient dissipation of the heat from the reflection layer therefore allows an efficient decrease in the temperature of the reflector.

### Additional Remark 6

The projection optical apparatus described in any one of the additional remarks 1 to 5, in which surface roughness of the heat conductive layer is greater than surface roughness of the reflection layer.

According to the configuration described above, which increases the surface roughness of the heat conductive layer, minute irregularities are formed at the surface of the heat conductive layer. The area over which the surface of the heat conductive layer is in contact with the air therefore increases, so that the heat dissipation capability of the heat conductive layer is enhanced, resulting in enhancement of the heat dissipation capability of the reflection layer, whereby an increase in the temperature of the reflector can be suppressed.

### Additional Remark 7

The projection optical apparatus described in any one of the additional remarks 1 to 6, in which the reflection layer has a concave shape.

According to the configuration described above, in which the reflector including the concave reflection layer is provided, a single-focus projection optical apparatus can be provided.

### Additional Remark 8

The projection optical apparatus described in any one of the additional remarks 1 to 7, in which the image light that exits via a reduction-side conjugate plane enters the optical system, and the reflector reflects and projects the light into an enlargement-side conjugate plane.

According to the configuration described above, a single-focus projection optical apparatus that projects a display image in the reduction-side conjugate plane into the enlargement-side conjugate plane to generate a projected image can be provided.

### Additional Remark 9

A projector including a light source apparatus that outputs light, a light modulator that modulates the light from the light source apparatus, and the projection optical apparatus described in any one of additional remarks 1 to 8 that projects modulated image light from the light modulator.

The thus configured projector, which includes the projection optical apparatus, which suppresses a partial shift of the image light that form the projected image caused by the heat of the reflector, can be a single-focus projector that projects a high-quality image onto a screen over a short distance.

The projector having the configuration described above, which can suppress a partial shift of the image light projected onto the screen, is optimum for a projector having an interactive function of reflecting on-screen detected position information in the projected image.

What is claimed is:

1. A projection optical apparatus comprising:
an optical system that image light enters;
a reflector that reflects the image light that exits out of the optical system; and
an enclosure that houses the optical system and the reflector,
wherein the reflector includes
a base having a first surface on which the image light is incident and a second surface opposite from the first surface,
a reflection layer provided at the first surface of the base, and
a heat conductive layer provided at the second surface of the base, and
the heat conductive layer has heat conductivity higher than heat conductivity of the base.

2. The projection optical apparatus according to claim 1,
wherein an illuminance distribution formed by the image light at the reflection layer has a first region where the illuminance is higher than a predetermined value, and
the heat conductive layer is provided at the second surface at least at a second region thereof corresponding to the first region.

3. The projection optical apparatus according to claim 1,
wherein the enclosure has a hermetically sealed structure that seals a housing space that houses the optical system and the reflector.

4. The projection optical apparatus according to claim 1,
wherein the base is made of a plastic material.

5. The projection optical apparatus according to claim 1,
wherein the reflection layer and the heat conductive layer are each made of a metal material, and
the heat conductive layer is thicker than the reflection layer.

6. The projection optical apparatus according to claim 1,
wherein surface roughness of the heat conductive layer is greater than surface roughness of the reflection layer.

7. The projection optical apparatus according to claim 1,
wherein the reflection layer has a concave shape.

8. The projection optical apparatus according to claim 1,
wherein the image light that exits via a reduction-side conjugate plane enters the optical system, and
the reflector reflects and projects the image light into an enlargement-side conjugate plane.

9. A projector comprising:
a light source apparatus that outputs light;
a light modulator that modulates the light from the light source apparatus; and
the projection optical apparatus according to claim 1 that projects modulated image light from the light modulator.
